(19) United States
(12) Patent Application Publication
(10) Pub. No.: US 2002/0158846 A1
(43) Pub. Date: Oct. 31, 2002

(54) Controlling cursor of a pointing device

(76) Inventor: Edward O. Clapper, Tempe, AZ (US)

Correspondence Address: Timothy N. Trop, TROP, PRUNER & HU, P.C., Ste. 100, 8554 Katy Freeway, Houston, TX, 77024, US

(21) Appl. No.: 09/846,074

(22) Filed: Apr. 30, 2001

(51) Int. Cl. G09G 5/00

(52) U.S. Cl. 345/168

(57) ABSTRACT

A way of controlling a cursor of a pointing device is provided. A method comprises detecting a selection of at least one key of a keyboard. The method further includes adjusting the cursor of the pointing device in response to detecting the selection of the at least one key of the keyboard.

### BACKGROUND

This invention relates generally to controlling a cursor, and, more particularly, to controlling the cursor of a pointing device.

Processor-based systems, which may include desktop computers, laptop computers, Internet appliances, and the like, have become popular over the years for a variety of reasons, such as improved performance and lower cost. As today's processor-based systems are evolving into more robust and versatile systems, so are the peripheral devices, such as pointing devices and keyboards, which interface with these processor-based systems.

Nowadays pointing devices, such as a mouse, touch pad, trackball, and the like, provide useful and convenient features to interface with processor-based systems. For example, a mouse commonly comes equipped with a wheel for allowing users to easily scroll through pages of text within applications. In some instances, in the interest of convenience and flexibility, pointing devices are integrated into keyboards.

While generally useful, the integration of pointing devices into keyboards may occasionally pose problems for end users. For example, designers commonly strive to place the pointing device within the keyboard in a location that is convenient and readily accessible to the end user. However, in doing so, the pointing device may be located in a vulnerable position such that it is accidentally or inadvertently activated while the end user is attempting to use the keyboard to input text.

Thus, there is a need to control the cursor of a pointing device.

### BRIEF DESCRIPTION OF THE DRAWINGS

The invention may be understood by reference to the following description taken in conjunction with the accompanying drawings, in which like reference numerals identify like elements, and in which:

FIG. 1 is a stylized block diagram of a processor-based system in accordance with one embodiment of the present invention;

FIG. 2 is a flow diagram of a method that may be employed by the processor-based system of FIG. 1, in accordance with one embodiment of the present invention;

FIG. 3 is a flow diagram of an alternative method that may be implemented by the processor-based system of FIG. 1, in accordance with one embodiment of the present invention; and

FIGS. 4A-4E illustrate one or more embodiments of the present invention in controlling the cursor of a pointing device that may be employed with the processor-based system of FIG. 1.

### DETAILED DESCRIPTION

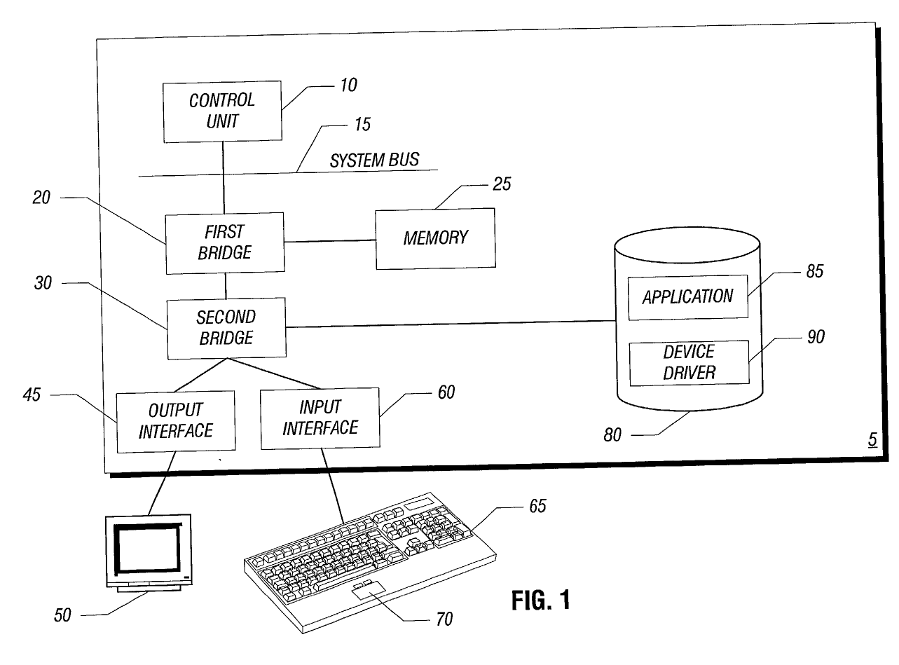

Referring now to FIG. 1, a block diagram of one embodiment of a processor-based system 5 is illustrated. Examples of the processor-based system 5 may include a personal digital assistant, laptop computer, desktop, Internet appliance and the like. The processor-based system 5 includes, in one embodiment, a control unit 10 that may be coupled to a system bus 15. A first bridge 20 may be coupled to the system bus 15, and to a memory 25, in one embodiment. The first bridge 20, in one embodiment, may be a north bridge of the processor-based system 5, for example.

The processor-based system 5, in one embodiment, includes a second bridge 30 that may be coupled to the first bridge 20. The second bridge 30, which may be a south bridge, is coupled to an output interface 45, in one embodiment. The output interface 45, for example, may be an interface to a display device 50. In one embodiment, the output interface 45 may be a video card. The second bridge 30, in one embodiment, may be coupled to an input interface 60. The input interface 60, for example, may interface with a keyboard 65. A “keyboard,” in one embodiment, may include any device that allows a user to enter text that is received by the processor-based system 5, where the text may include alphabet characters, numeric characters, other displayable characters, or a combination thereof. The keyboard 65, in one embodiment, may have an integrated pointing device 70, such as a mouse, trackball, touchpads, and the like.

The processor-based system 5, in one embodiment, includes a storage unit 80 that may be coupled to the second bridge 30. The storage unit 80 may include an application 85 (described in more detail below) that contains one or more executable instructions for allowing a user to configure one of a variety of options to control the cursor of the pointing device 70 of the keyboard 65. The storage unit 80 may, in one embodiment, have one or more device drivers 90 for controlling devices such as the keyboard 65, display device 50, and the like. Additionally, although not shown, an operating system for the processor-based system 5 may be resident in the storage unit 80.

For clarity and ease of illustration, only selected functional blocks of the processor-based system 5 are illustrated in FIG. 1, although those skilled in the art will appreciate that the processor-based system 5 may comprise additional or fewer functional blocks. Additionally, it should be appreciated that FIG. 1 illustrates one possible configuration of the processor-based system 5 and that other configurations comprising different interconnections may also be possible without deviating from the spirit and scope of one or more embodiments of the present invention. For example, in an alternative embodiment, the processor-based system 5 may include additional or fewer bridges 20, 30. As an additional example, in an alternative embodiment, the output interface 45 may be coupled to the first bridge 20 directly. Similarly, other configurations may be possible.

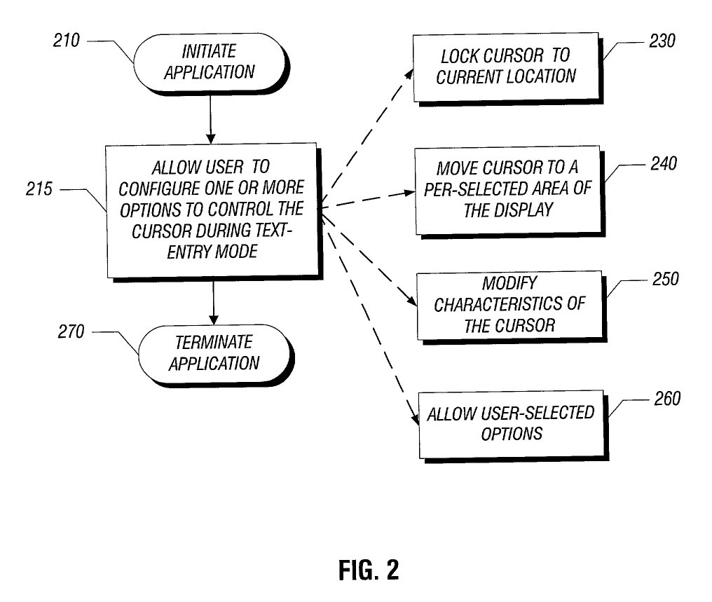

Referring now to FIG. 2, a flow diagram of a method in accordance with one embodiment of the present invention is illustrated. A user may initiate (at 210) the application 85 (see FIG. 2) that is stored in the storage unit 80 of the processor-based system 5, in one embodiment. The application 85, in one embodiment, as described below, allows (at 215) a user to configure one or more options to control the cursor of the pointing device 70 (see FIG. 2) during a mode (sometimes referred to as “text-entry” mode) when the user is entering text using the keys of the keyboard 65. Controlling the “cursor” may, in one embodiment, refer to changing the state of the cursor of the pointing device 70, including moving the position of the cursor, hiding the cursor, locking or freezing the cursor, re-sizing the cursor, and the like.

The term “text-entry mode”, as utilized herein, may refer to a selected period of time that the user starts to enter text using the keyboard 65 or it may refer to a time interval during which the user is entering text. It should be appreciated that in the course of entering text, the user may have some pauses caused by distractions or user's personal style of typing. In such situations, the entire text-entering period may constitute a single text-entry mode or, alternatively, it may constitute a plurality of text-entry modes. In one embodiment, the length of the pause between keystrokes may indicate whether the user is still in a text-entry mode.

The application 85, for example, may allow the user to configure an option where the cursor of the pointing device 70 locks (at 230) at its current location at the time the user starts to input text using the keys of the keyboard 65, thereby reducing the likelihood of the user inadvertently activating the pointing device 70. Thus, as described in more detail below, the location of the cursor of the pointing device 70 may be locked or “frozen” at its current position on the display device 50 (see FIG. 2) as the user inputs text.

In one embodiment, the application 85 may allow the user to configure an option where the cursor of the pointing device 70 is moved (at 240) to a pre-selected display area of the display device 50 during text-entry mode. Moving the cursor to the pre-selected display area on the display device 50 may have a two-fold advantage. First, moving the cursor to another display area may prevent against interference caused by accidental contact with the pointing device 70 while entering text. Second, moving the cursor to the pre-selected display area may allow the user to readily determine the whereabouts of the cursor of the pointing device 70 after the user is finished entering text, for example.

In one embodiment, the application 85 may allow the user to configure an option where one or more of the selected features of the cursor of the pointing device 70 are modified (at 250) during the text-entry mode. For example, the processor-based system 5 may modify the shape, size, and/or other traits of the cursor of the pointing device 70 during the text-entry mode.

In one embodiment, the application 85 may allow the user to configure the cursor of the pointing device 70 using one of a variety of user-selected options. That is, in one embodiment, the user may control the cursor of the pointing device 70 during the text-entry mode in a manner consistent with the user's own personal preference. For example, in one embodiment, the user may wish to control the cursor depending on one or more of the pre-selected keys of the keyboard 65. That is, in one embodiment, the user may wish to control (e.g., move, lock) the cursor of the pointing device 70 only when using keys that are in close proximity to the pointing device 70. Controlling the cursor when entering text using keys that are in close proximity to the location of the pointing device 70 on the keyboard 65 may be beneficial since the likelihood of accidental or intentional contact with the pointing device 70 may be greater during those instances. In an alternative embodiment, the application 85 may allow the user to designate certain keys that do not cause the processor-based system 5 to control the cursor of the pointing device 70. For example, in graphic applications, a simultaneous use of a shift key (or some other key) plus the pointing device 70 may be desirable, and, as such, the user may wish to use selected keys (e.g., shift key, control key) while using the pointing device 70. To accommodate the concurrent use of keys of the keyboard 75 and the pointing device 70, the application 65 may allow the user to configure an option where the processor-based system 5 does not control the cursor of the pointing device when certain keys are activated or selected by the user.

Upon configuring (at 215) the one or more options to control the cursor during the text-entry mode, the user may terminate (at 270) the application 85.

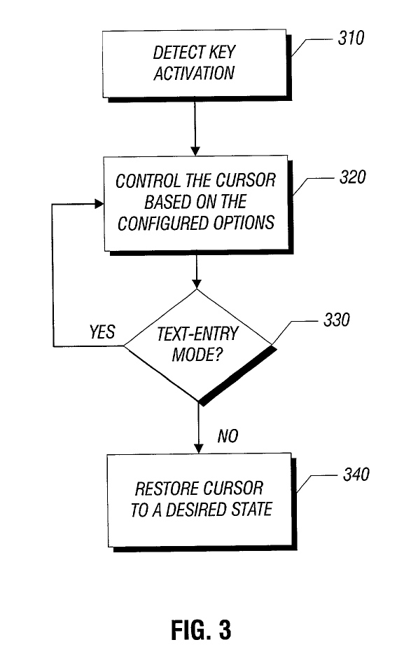

Referring now to FIG. 3, a flow diagram of a method that may be implemented by the processor-based system 5 of FIG. 1 is illustrated, in accordance with one embodiment of the present invention. The processor-based system 5 detects (at 310) key activation by the user, in one embodiment. Detecting key activation may include, for example, detecting a selection of a key of the keyboard 65 by a user. Thus, in one embodiment, a key activation event may occur when a user starts to type text using the keyboard 65. The key activation event, in one embodiment, may signify the start of the text-entry mode.

The processor-based system 5, in one embodiment, controls (at 320) the cursor of the pointing device 70 based on the options configured (at 215—see FIG. 2) by the user. Thus, the processor-based system 5, in one embodiment, controls the cursor of the pointing device 70 based on the configured options. For example, the cursor of the pointing device 70 may be moved to a pre-selected location, locked or frozen, or controlled in another manner as desired by the user.

The processor-based system 5, in one embodiment, determines (at 330) if the text-entry mode is complete. In one embodiment, the processor-based system 5 may wait a pre-selected amount of time between keystrokes to determine if the user is finished entering text. In one embodiment, the processor-based system 5 continues to control (at 320) the cursor of the pointing device 70 in a manner consistent with the configured options while keystrokes are (or key activation is) detected.

If, however, the processor-based system 5 detects that the text-entry mode is complete (e.g., no keystrokes or key activation detected for a pre-selected time interval), then the processor-based system 5, in one embodiment, restores (at 340) the cursor of the pointing device 70 to a desired state. The desired state may, in one embodiment, include returning the cursor to its normal state (a state prior to the text-entry mode), which may entail re-positioning the cursor to its initial state as well as returning full control of the cursor to the user. In another embodiment the desired state may include simply returning the control of the cursor to the user without re-positioning the cursor.

In one embodiment, the processor-based system 5 may allow the user to take control of the cursor of the pointing device 70 at any time. For example, in one embodiment, the user may regain control of the cursor by double clicking the pointing device 70, pressing a pre-selected key on the keyboard 65, or any other predefined action that indicates to the processor-based system 5 that the user wishes either to use the pointing device 70 or otherwise regain control of it.

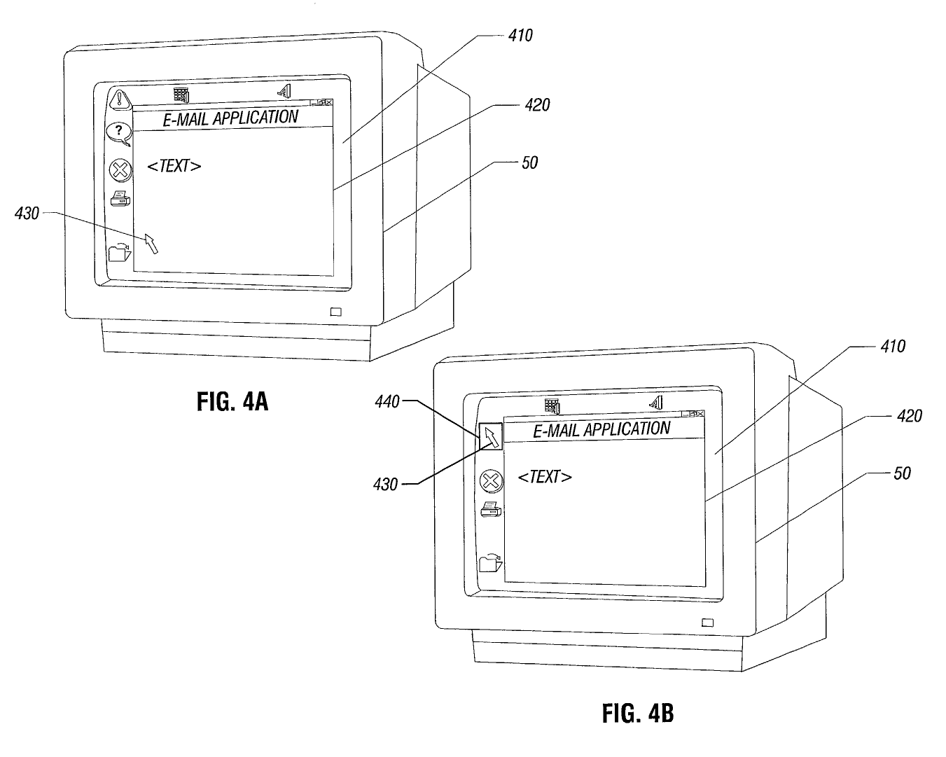

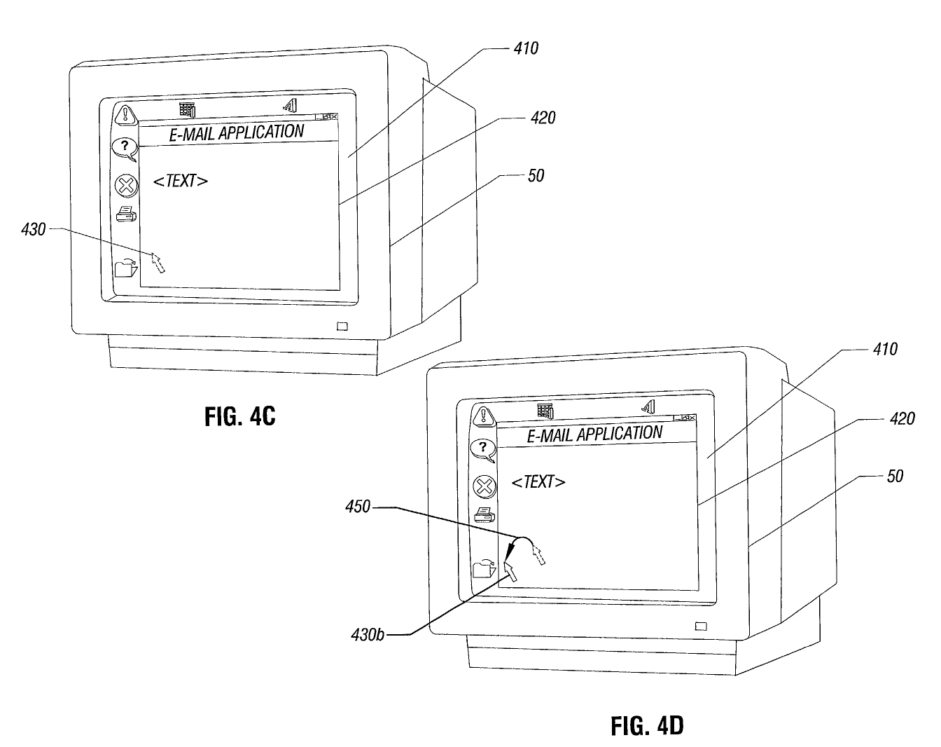

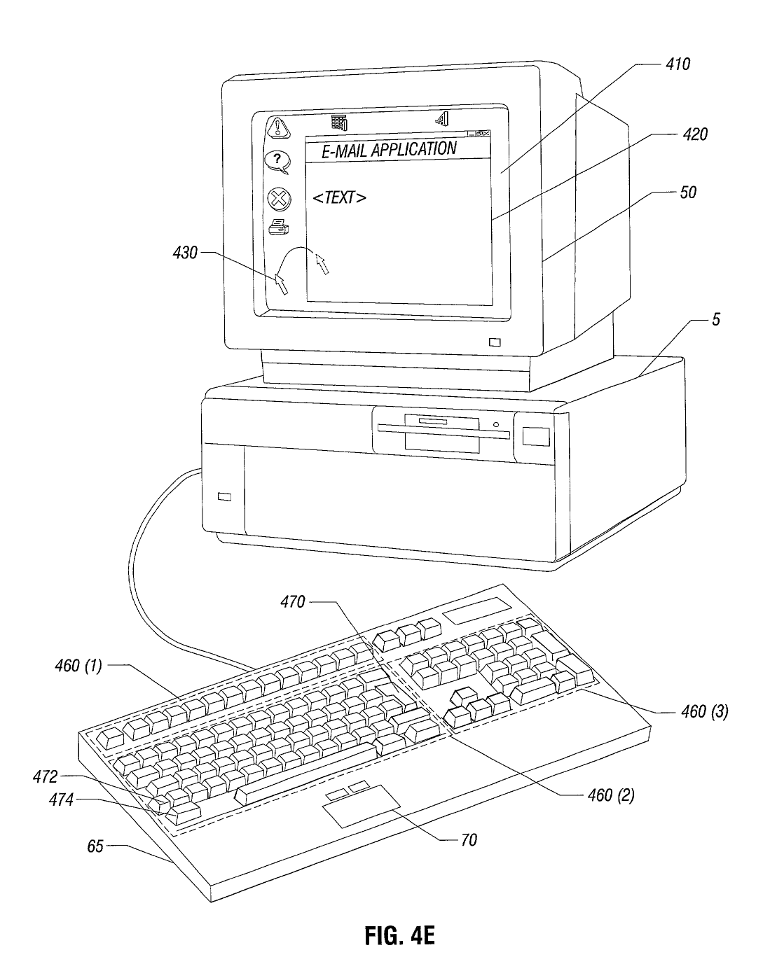

Referring now to FIGS. 4A-4E, illustrations of one or more embodiments of the present invention are provided. Specifically, FIGS. 4A-4E depict the display device 50 of the processor-based system 5 that shows various examples of the cursor of the pointing device 70 during the text-entry mode. In the illustrated embodiment, although not so limited, the pointing device 70 is a touch pad device. In FIG. 4A, shown on the display device 50, is an operating system desktop 410 having a window 420 of an electronic mail (e-mail) application displayed on top of the desktop or a graphical user interface 410. It should be understood that an e-mail application window 420 is shown for illustrative purposes and that the one or more embodiments of the present invention may be applicable to any application (beyond the e-mail application 420) where controlling the cursor of the pointing device 70 may be desirable.

In FIG. 4A, as the user enters text (e.g., a key activation is detected), for example, into the e-mail application window 420 using the keys of the keyboard 65, the processor-based system 5, in accordance with one embodiment of the present invention, locks the cursor 430 of the pointing device 70 in its current location. Locking or freezing the cursor 430 while the user is in the text-entry mode may thus, in one embodiment, reduce the possibility of the user accidentally engaging the pointing device 70 while typing. In one embodiment, once the processor-based system 5 determines that the user is no longer entering text, the processor-based system 5 may release (or unlock) the cursor 430 so that the cursor 430 may be maneuvered freely as desired. In an alternative embodiment, the user may release the cursor 430 of the pointing device 70 by one of a variety of indications, such as by double clicking a button of the pointing device 70, depressing a button of the pointing device 70 for a pre-selected time interval, or depressing a selected key on a keyboard 65, and the like.

In FIG. 4B, the position of the cursor 430 of the pointing device 70 is moved, in one embodiment, to a pre-selected area 440 of the display device 50 in response to detecting a key activation. In one embodiment, moving the cursor 430 of the pointing device 70 to the pre-selected area 440 may assist the user in keeping the cursor 430 out of the way while the user types text into an application, such as the e-mail application 420. Moreover, by moving the cursor 430 to a known area on the display device 50, the user may be aware of the location of the cursor 430 and, therefore, may quickly locate the cursor 430 when desired.

In FIG. 4C, the cursor 430 of the pointing device 70 is hidden, moved, and locked, in one embodiment, in response to detecting key activation by the user. That is, in one embodiment, the processor-based system 5 may temporarily hide, move, and lock the cursor 430 until the termination of text-entry mode or until the user desires to change the cursor 430 by regaining control of the cursor 430, for example. The cursor 430 in FIG. 4C is shown with dotted lines to illustrate that it is hidden from the user's view.

In FIG. 4D, the sensitivity of the cursor 430 of the pointing device 70 is modified, in one embodiment, in response to detecting key activation. That is, the processor-based system 5, in the illustrated embodiment, reduces the sensitivity of the cursor 430 in a manner that inhibits the movement of the cursor 430 when the user engages the pointing device 70. Thus, even if the user accidentally or unintentionally makes substantial contact with the pointing device 70, the cursor 430, in accordance with one embodiment of the present invention, may move only slightly. An arrow 450 in FIG. 4D illustrates the movement of the cursor 430 from its original position to a new position when the user engages the pointing device 70.

FIG. 4E illustrates an example of the processor-based system 5 that is coupled to one embodiment of the display device 50 and the keyboard 65 having the pointing device 70. The keyboard 65 includes, in one embodiment, one or more keys with which the user may enter text. The keys of the keyboard 65 are grouped into a plurality of sections 460(1-3). The designated sections 460(1-3) are arbitrary and are provided herein for illustrative purposes, as described in more detail below.

In FIG. 4E, the processor-based system 5 resizes and moves the cursor 430 of the pointing device 70 based on a selected key's proximity to the pointing device 70. That is, in some embodiments, it may be desirable to control the cursor of the pointing device 70 only when the user selects keys are relatively closer to the location of the pointing device 70, primarily because the likelihood of accidental contact with the pointing device 70 may be greater when the user selects keys that are situated relatively close to the pointing device 70. For example, in one embodiment, when the user selects one or more keys in the section 460(2), which may have keys that are closer in proximity to the pointing device 70, the cursor 430 is resized and moved to another location on the display device 50. While in another embodiment, the processor-based system 5 may not modify the cursor 430 if one or more of the keys are selected from the sections 460(1) and 460(3), since the keys in these sections 460(1) and 460(3) may not be in close proximity to the pointing device 70, and thereby, when utilized, are likely to result in fewer accidental contacts with the pointing device 70.

In another embodiment, based on the options configured (at 215—see FIG. 2) by the user, the processor-based system 5 may not control the cursor 430 of the pointing device 70 in response to the activation of one or more user-selected keys, such as the enter key 470, shift key 472, and/or control key 474. This may be useful in one embodiment, for example, if the user generally desires to control the cursor of the pointing device 70 during the text-entry mode but at the same time desires some flexibility in using the user-selected keys (e.g., shift key 472, control key 474) of the keyboard 65 in conjunction with the pointing device 70.

The above-described methods may be implemented at any variety of software levels, such as at the device driver level, the operating system level, the application level, or any other desirable level. Furthermore, some or all portions of the above-described methods may be implemented in the keyboard 65 (see FIG. 2) (as opposed to the processor-based system 5), in accordance with one or more embodiments of the present invention. In one embodiment, selected portions of the methods may be implemented in the microcode of the keyboard 65, for example.

The various system layers, routines, or modules may be executable control units (such as control unit 10 (see FIG. 1) in the processor-based system 5). Each control unit may include a microprocessor, a microcontroller, a processor card (including one or more microprocessors or controllers), or other control or computing devices.

The storage units referred to in this discussion may include one or more machine-readable storage media for storing data and instructions. The storage media may include different forms or memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions when executed by a respective control unit cause the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. An apparatus comprising:
an interface; and
a controller communicatively coupled to the interface, the controller to detect a key activation and to adjust a cursor of a pointing device in response to detecting the key activation.

2. The apparatus of claim 1, wherein the controller moves the cursor to a pre-selected area on a display device in response to detecting the key activation.

3. The apparatus of claim 1, wherein the controller prevents movement of the cursor in response to detecting the key activation.

4. The apparatus of claim 1, wherein the controller reduces at least one of a movement and sensitivity of the cursor in response to detecting the key activation.

5. The apparatus of claim 1, wherein the controller adjusts the cursor in response to activation of a selected key.

6. The apparatus of claim 1, wherein the controller adjusts the cursor until key activation is no longer detected.

7. The apparatus of claim 1, wherein the controller hides the cursor from view in response to detecting the key activation.

8. The apparatus of claim 1, wherein the controller adjusts the cursor of one of a trackball device, touch pad device, and mouse device.

9. The apparatus of claim 1, wherein the controller detects a selection of a key of a keyboard.

10. A method, comprising:
detecting a selection of at least one key of a keyboard; and
adjusting a cursor of a pointing device in response to detecting the selection of the at least one key.

11. The method of claim 10, wherein adjusting the cursor comprises moving the cursor to a pre-selected area of a graphical user interface.

12. The method of claim 10, wherein adjusting the cursor comprises re-sizing the cursor in response to detecting the selection of the at least one key.

13. The method of claim 10, wherein adjusting the cursor comprises preventing the cursor from moving.

14. The method of claim 10, wherein adjusting the cursor comprises adjusting the cursor based on a selection of a pre-selected key.

15. An article comprising one or more machine-readable storage media containing instructions that when executed enable a processor to:
receive an option to control a cursor of a pointing device in response to detecting a key activation; and
store the option in a storage unit.

16. The article of claim 15, wherein the instructions when executed enable the processor to receive the option comprising at least one of moving the cursor to a preselected area on a display device, freezing the position of the cursor, and adjusting the size of the cursor.

17. An article comprising one or more machine-readable storage media containing instructions that when executed enable a processor to:
detect a key activation; and
control a cursor of a pointing device in response to detecting the key activation.

18. The article of claim 17, wherein the instructions when executed enable the processor to lock the cursor of the pointing device at a selected position in response to detecting the key activation.

19. The article of claim 17, wherein the instructions when executed enable the processor to move the cursor of the pointing device to a selected area on a display device in response to detecting the key activation.

20. The article of claim 17, wherein the instructions when executed enable the processor to resize the cursor of the pointing device to a selected size in response to detecting the key activation.

21. The article of claim 17, wherein the instructions when executed enable the processor to adjust the sensitivity of the pointing device in response to detecting the key activation.

22. The article of claim 17, wherein the instructions when executed enable the processor to control the cursor of the pointing device based on the key activation of one or more pre-selected keys.

23. An apparatus comprising:
an interface; and
a controller communicatively coupled to the interface, the controller to adjust a cursor of a pointing device during text-entry mode.

24. The apparatus of claim 23, wherein the controller disables the movement of the cursor during the text-entry mode.

25. The apparatus of claim 23, wherein the controller adjust the cursor based on a location of a selected key during the text-entry mode relative to the location of the pointing device.

26. A system comprising:
a pointing device;
a keyboard having one or more keys; and
a controller to adjust a cursor of the pointing device in response to detecting activation of the one or more keys of the keyboard.

27. The system of claim 26, wherein the keyboard comprises the pointing device and wherein the pointing device is at least one of a trackball device, mouse device, and touch pad device.

28. The system of claim 26, wherein the controller moves the cursor to a pre-selected area on a display device in response to detecting the activation of the one or more keys of the keyboard.

29. The system of claim 26, wherein the controller prevents the cursor from moving in response to detecting the activation of the one or more keys of the keyboard.

30. The system of claim 26, wherein the controller stops adjusting the cursor of the pointing device if no activation of the one or more keys is detected.
